(19) United States
(12) Patent Application Publication
(10) Pub. No.: US 2024/0157793 A1
(43) Pub. Date: May 16, 2024

(54) SWITCH DEVICE

(71) Applicant: TOYODA GOSEI CO., LTD., Kiyosu-shi (JP)

(72) Inventors: Yoshinori MASATSUGU, Aichi-ken (JP); Takayuki KAMIYA, Aichi-ken (JP); Yusuke UESHIMA, Aichi-ken (JP)

(21) Appl. No.: 18/494,951

(22) Filed: Oct. 26, 2023

(30) Foreign Application Priority Data
Nov. 10, 2022 (JP) 2022-180510

(51) Int. Cl. B60K 35/00

(52) U.S. Cl. CPC B60K 35/00; B60K 2370/1434; B60K 2370/1446; B60K 2370/332; B60K 2370/794

(57) ABSTRACT

A switch device includes a panel having a first design and a second design, a first switch configured to detect an operation performed on the first design displayed on the panel, a second switch configured to detect an operation performed on the second design displayed on the panel, and a control unit configured to set a display state in which the first design is displayed and a non-display state in which the second design is not displayed, in an initial state, and switch the second design from the non-display state to the display state based on an operation to the first switch.

### CROSS-REFERENCE RELATED APPLICATIONS

This application is based on and claims priority under 35 USC 119 from Japanese Patent Application No. 2022-180510 filed on Nov. 10, 2022.

### TECHNICAL FIELD

The present invention relates to a switch device.

As a technique of the related art, there is known a switch device for a vehicle including a decorative panel which is provided in an interior member of a vehicle and has transparency with a pattern or a color, an electrode which is disposed at a predetermined position on a back side of the decorative panel, a control unit which detects a change in electrostatic capacitance of the electrode and controls a predetermined operation of an in-vehicle device, and a light source which illuminates a position where the electrode is disposed or a vicinity thereof from the back side of the decorative panel and displays a pattern indicating an operation position on a front side of the decorative panel (for example, see JP 2006-321336 A).

When a change in the electrostatic capacitance of the electrode is detected while the pattern is not displayed, the control unit of the switch device for a vehicle turns on the light source to display the pattern.

The switch device for a vehicle of the related art has a problem that, when no pattern is displayed, it is difficult to understand the positions of the electrodes, that is, a position of a switch, and a visibility of the switch is low.

### SUMMARY OF INVENTION

An object of the present invention is to provide a switch device capable of improving a visibility.

According to an aspect of the present disclosure, there is provided a switch device including a panel having a first design and a second design, a first switch configured to detect an operation performed on the first design displayed on the panel, a second switch configured to detect an operation performed on the second design displayed on the panel, and a control unit configured to set a display state in which the first design is displayed and a non-display state in which the second design is not displayed, in an initial state, and switch the second design from the non-display state to the display state based on an operation to the first switch.

According to the present invention, the visibility can be improved.

### BRIEF DESCRIPTION OF DRAWINGS

FIG. 1A is an example of a block diagram of a switch device according to an embodiment, and FIG. 1B is a diagram illustrating an example of a panel.

FIG. 2 is a diagram illustrating an example of an inner portion of a vehicle on which the switch device is mounted.

FIG. 3A is a diagram illustrating an example of a case where a second switch of the switch device according to the embodiment is in a non-display state, and FIG. 3B is a diagram illustrating an example of a case where the second switch is in a display state.

FIG. 4A is a diagram illustrating an example of a right door on which the switch device according to the embodiment is disposed, and FIG. 4B is a diagram illustrating an example of a left door on which the switch device is disposed.

FIG. 5A and FIG. 5B are diagrams illustrating an example of a first design and a second design in a case where a switch device according to a modified example can operate a mirror adjustment device of a vehicle, and FIG. 5C and FIG. 5D are diagrams illustrating an example of the first design and the second design in a case where the switch device can operate a seat adjustment device of the vehicle.

FIG. 6 is a flowchart illustrating an example of an operation of the switch device according to the embodiment.

### DESCRIPTION OF EMBODIMENTS

### Summary of Embodiment

A switch device according to an embodiment includes a panel having a first design and a second design, a first switch configured to detect an operation performed on the first design displayed on the panel, a second switch configured to detect an operation performed on the second design displayed on the panel, and a control unit configured to set a display state in which the first design is displayed and a non-display state in which the second design is not displayed, in an initial state, and switch the second design from the non-display state to the display state based on an operation to the first switch.

In the switch device, since the second design is switched from the non-display state to the display state by the operation to the first switch, it is possible to improve visibility as compared with a case where the switch in the non-display state is operated to switch to the display state.

### Embodiment

### Overview of Switch Device 1

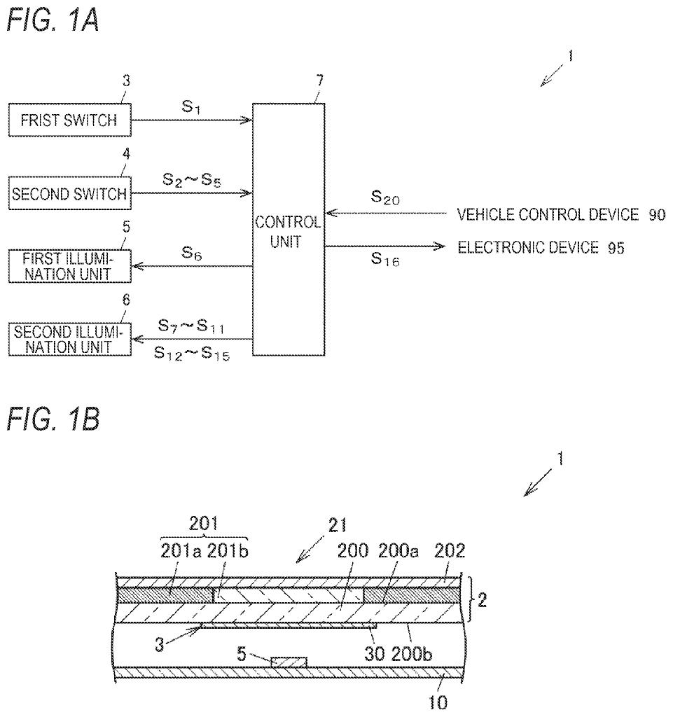

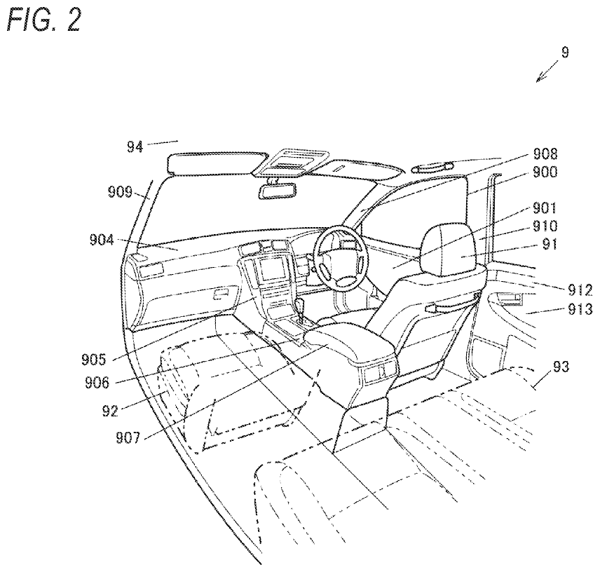

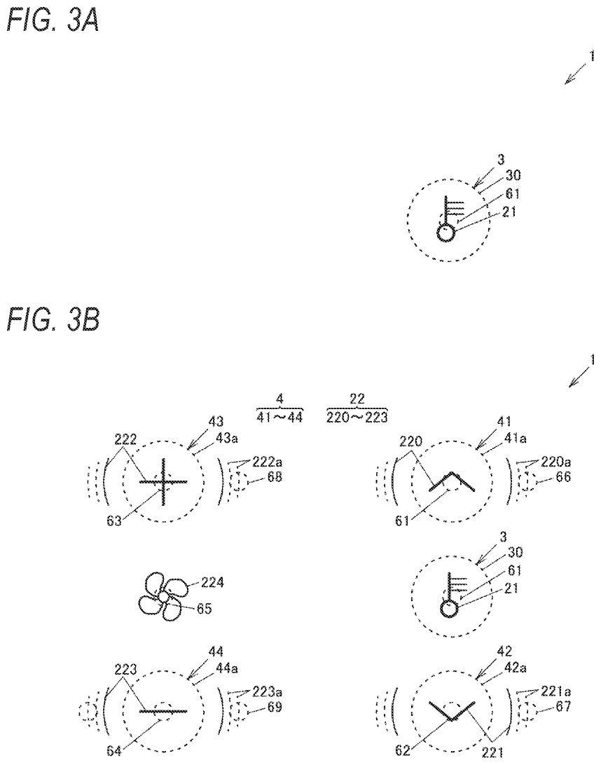

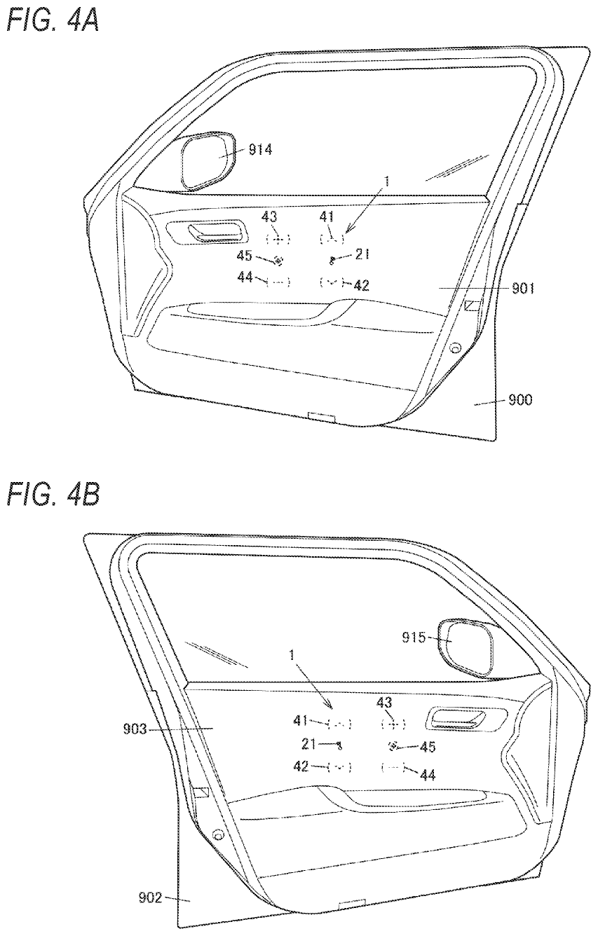

FIG. 1A is an example of a block diagram of a switch device according to an embodiment, and FIG. 1B is a diagram illustrating an example of a panel. FIG. 2 is a diagram illustrating an example of an inner portion of a vehicle on which the switch device is mounted. FIG. 3A is a diagram illustrating an example of a case where a second switch of the switch device according to the embodiment is in a non-display state, and FIG. 3B is a diagram illustrating an example of a case where the second switch is in a display state. FIG. 4A is a diagram illustrating an example of a right door on which the switch device according to the embodiment is disposed, and FIG. 4B is a diagram illustrating an example of a left door on which the switch device is disposed.

In each of the drawings according to the embodiment described below, the ratio or shape between figures may be different from the actual ratio or shape. In FIG. 1A, flows of main signals and information are indicated by arrows.

As illustrated in FIGS. 1A to 3B, a switch device 1 schematically includes a panel 2 which has a first design 21 and a second design 22, a first switch 3 which detects an operation performed on the first design 21 displayed on the panel 2, a second switch 4 which detects an operation performed on the second design 22 displayed on the panel 2, and a control unit 7 which sets a display state in which the first design 21 is displayed and a non-display state in which the second design 22 is not displayed, in an initial state, and switches the second design 22 from the non-display state to the display state based on the operation to the first switch 3.

As illustrated in FIG. 2, the panel 2 is mounted on a vehicle 9, but is not limited thereto. The first design 21 according to the present embodiment is displayed on the panel 2 with unlocking of the vehicle 9 as the initial state as an example, but is not limited thereto. As an example of the switch device 1, as illustrated in FIGS. 2, 4A, and 4B, the panel 2 may include a door trim 901 of a door 900 on the driver's seat 91 side, a door trim 903 of a door 902 on a front passenger's seat 92 side, an instrument panel 904, a center console 905, a floor console 906, a console box 907, an A-pillar 908 on the driver's seat 91 side, an A-pillar 909 on the front passenger's seat 92 side, a B-pillar 910 on the driver's seat 91 side, a B-pillar on the front passenger's seat 92 side, door trims 913 of left and right doors 912 on the rear seat 93 side, a ceiling 94, and the like. The panel 2 is not limited to this.

The switch device 1 operates an electronic device 95 disposed in the vehicle 9. The electronic device 95 is, for example, a vehicle control device 90 which performs setting of the entire vehicle and a control of an autonomous driving function, an air conditioner which adjusts a temperature in a vehicle compartment, a navigation device which guides a current map and a destination, a display device which displays an image, a seat device which controls a position, an inclination, and the like of a seat, a music and video reproduction device which reproduces music and video, and the like.

As illustrated in FIG. 1A, the switch device 1 according to the present embodiment includes a first illumination unit 5 which illuminates the first design 21 and displays the first design 21 on the panel 2, and a second illumination unit 6 which illuminates the second design 22 and displays the second design 22 on the panel 2. The switch device 1 may be configured by an organic electro-luminescence (EL) display or the like in which the panel 2 can display or not display the first design 21 and the second design 22.

Hereinafter, the switch device 1 is configured as the electronic device 95 to adjust the set temperature and an air volume of the air conditioner as an example, but is not limited thereto.

(Configuration of Panel 2)

As an example, as illustrated in FIG. 1B, the panel 2 includes a panel main body 200, a design layer 201, and a smoke film 202. The panel main body 200 is formed in a plate shape using a transparent resin material. The panel main body 200 is not limited to a flat surface, and may be a curved surface. As an example, the design layer 201 is formed on the surface 200a of the panel main body 200, and includes a light shielding portions 201a having a low light transmittance and transmission portions 201b having a high light transmittance. The first design 21 and the second design 22 are formed by a combination of the light shielding portion 201a and the transmission portion 201b. The smoke film 202 is formed on the design layer 201, and when the first design 21 and the second design 22 are in the non-display state, the smoke film 202 is configured to have such a transmittance which the designs of the first design 21 and the second design 22 are not displayed through the smoke film 202, that is, black out in the non-display state.

(Configuration of First Design 21)

The first design 21 is a design related to the second design 22. That is, when viewing the first design 21, a user can associate the electronic device 95 operable by the switch device 1. As an example, as illustrated in FIGS. 3A and 3B, the first design 21 is a design imitating a thermometer associated with the air conditioner. Accordingly, the second design 22 is a design related to other functions of the air conditioner as a related design. In addition, the second design 22 includes a design related to adjustment of a set temperature as a related design. As described above, the switch device 1 displays only the first design 21 in the initial state, so that it is possible to prevent inconvenience caused by a large number of designs to be displayed.

Although the number of first designs 21 according to the present embodiment is one, the present invention is not limited thereto, and a plurality of first designs 21 may be provided. Although the first design 21 is illuminated in accordance with the unlocking of the vehicle 9 as an example, the present invention is not limited thereto, and the first design 21 may be illuminated in accordance with start of a drive device of the vehicle 9.

(Configuration of Second Design 22)

As an example, as illustrated in FIGS. 3A and 3B, the second design 22 includes a high set temperature design 220, a low set temperature design 221, a high air volume design 222, a low air volume design 223, and an air volume design 224.

As illustrated in FIG. 3B, the switch device 1 has a reception design displayed on the panel 2 in response to reception of an operation to the second switch 4. The switch device 1 according to the present embodiment includes a reception design 220a, a reception design 221a, a reception design 222a, and a reception design 223a. The reception design 220a, the reception design 221a, the reception design 222a, and the reception design 223a serve as an answer back for receiving an operation by changing the display state from the non-display state in response to an operation of a related switch.

The high set temperature design 220 and the low set temperature design 221 are designs related to adjustment of the set temperature of the air conditioner. The first design 21 is disposed between the high set temperature design 220 and the low set temperature design 221 which are related designs. The reception design 220a enters the display state when an operation performed on the high set temperature design 220 is received. The reception design 221a enters the display state when an operation performed on the low set temperature design 221 is received.

The high air volume design 222 and the low air volume design 223 are designs related to adjustment of the air volume of the air conditioner. The air volume design 224, which is a design imitating wind, is disposed between the high air volume design 222 and the low air volume design 223. The reception design 222a enters the display state when an operation performed on the high air volume design 222 is received. In addition, the reception design 223a enters the display state when an operation performed on the low air volume design 223 is received.

As illustrated in FIGS. 4A and 4B, the switch device 1 is disposed on the door trim 901 of the door 900 on the driver's seat 91 side and the door trim 903 of the door 902 on the front passenger's seat 92 side. Accordingly, parts of the door trim 901 and the door trim 903 constitute the panel 2. The second design 22 is in the non-display state until the user operates the first switch 3 of the first design 21. In FIGS. 4A and 4B, the display state is indicated by a solid line, and the non-display state is indicated by a dotted line.

The second design 22 may be in the non-display state when a touch operation is not performed for a predetermined time.

(Modified Example of First Design 21 and Second Design 22)

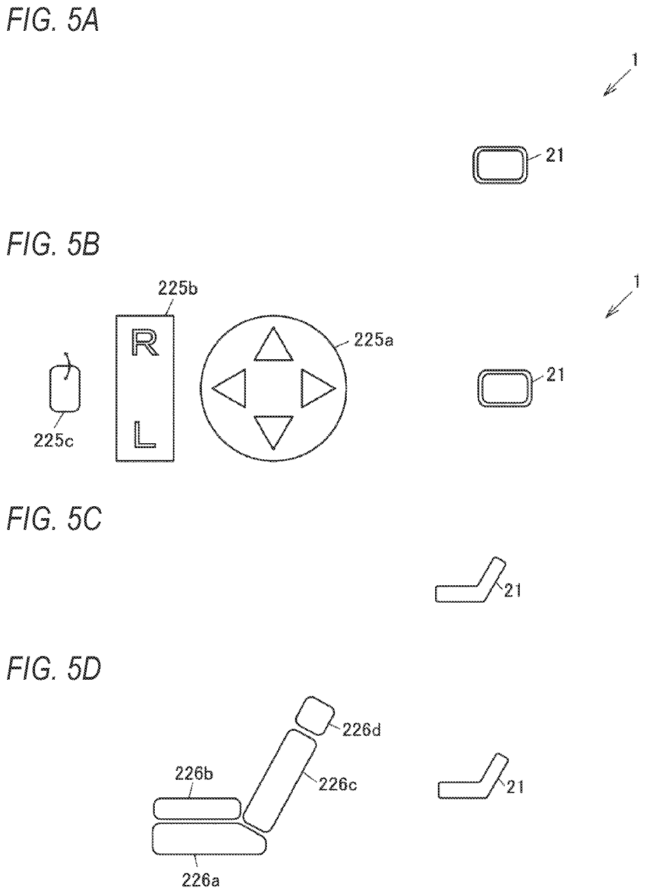

FIGS. 5A and 5B are diagrams illustrating an example of a first design and a second design in a case where a switch device according to a modified example can operate a mirror adjustment device of a vehicle, and FIG. 5C and FIG. 5D are diagrams illustrating an example of the first design and the second design in a case where the switch device can operate a seat adjustment device of the vehicle. In FIGS. 5A and 5C, the second design 22 is in the non-display state. In FIGS. 5B and 5D, the second design 22 is in the display state.

The first design 21 illustrated in FIGS. 5A and 5B is a design imitating a right mirror 914 and a left mirror 915 of the vehicle which can be adjusted by the switch device 1. The second design 22 illustrated in FIG. 5B includes, as an example, a cross design 225a indicating a function of adjusting an angle of the selected mirror, a selection design 225b indicating a function of selecting the right mirror 914 or the left mirror 915, and a folding design 225c indicating a function of folding the right mirror 914 and the left mirror 915.

When the user performs an operation on the first design 21, the second design 22 is switched from the non-display state illustrated in FIG. 5A to the display state illustrated in FIG. 5B.

The first design 21 illustrated in FIGS. 5C and 5D is a design imitating a seat of the vehicle 9 which can be adjusted by the switch device 1. The second design 22 illustrated in FIG. 5D includes, as an example, a front-rear design 226a indicating a function of adjusting a front-rear position of the seat, a height design 226b indicating a function of adjusting the height of the seat, an angle adjustment design 226c indicating a function of adjusting an angle of the seat back, and an angle adjustment design 226d indicating a function of adjusting an angle of a head rest.

When the user performs an operation on the first design 21, the second design 22 is switched from the non-display state illustrated in FIG. 5C to the display state illustrated in FIG. 5D.

As an example, the switch device 1 may be configured to display the first design 21 and the second design 22 illustrated in FIG. 3B and the first design 21 and the second design 22 illustrated in FIG. 5B on the door trim 901 of the door 900 on the driver's seat 91 side. In this case, as an example, the first design 21 illustrated in FIG. 3B and the first design 21 illustrated in FIG. 5B are in the display state, and when one of the first designs 21 is operated, the second design 22 on the operated side is in the display state.

The switch device 1 may further be configured to display the first design 21 and the second design 22 illustrated in FIG. 5D. The switch device 1 may be configured to display the first design 21 and the second design 22 illustrated in FIG. 3B and the first design 21 and the second design 22 illustrated in FIG. 5D on the door trim 903 on the front passenger's seat 92 side or the door trim on the rear seat side. The switch device 1 may be configured to display a plurality of first designs 21 and a plurality of second designs 22 corresponding to a plurality of electronic devices 95 to be operated on the panel 2.

(Configuration of First Switch 3 and Second Switch 4)

The first switch 3 and the second switch 4 are configured as an electrostatic capacitance type touch sensor, for example. As illustrated in FIGS. 3A and 3B, the first switch 3 includes a detection electrode 30 below the first design 21.

The second switch 4 includes a plurality of switches, has the second design 22 for each of the plurality of switches, and is assigned with a function to be operated. Since the second design 22 according to the present embodiment includes the high set temperature design 220, the low set temperature design 221, the high air volume design 222, and the low air volume design 223, a detection electrode 41a of a switch 41, a detection electrode 42a of a switch 42, a detection electrode 43a of a switch 43, and a detection electrode 44a of a switch 44 are provided according to these designs.

The detection electrode 30 and the detection electrodes 41a to 44a are each formed in a circular plate shape using a transparent electrode as an example, but are not limited thereto. The detection electrode 30 and the detection electrodes 41a to 44a are disposed on a back surface 200b of the panel 2.

The first switch 3 detects a touch operation performed on the first design 21 by the detection electrode 30. The switch 41 of the second switch 4 detects a touch operation performed on the high set temperature design 220 by the detection electrode 41a. Similarly, the switches 42 to 44 of the second switch 4 respectively detect touch operations performed on the low set temperature design 221 to the low air volume design 223 by the detection electrodes 42a to 44a.

The first switch 3 and the second switch 4 may be configured to detect not only contact but also proximity to the panel 2.

The detection electrode 30 and the detection electrodes 41a to 44a are electrically connected to the control unit 7. Further, the detection electrode 30 and the detection electrodes 41a to 44a output detection signals S₁ to S₅ corresponding to detected changes in electrostatic capacitance to the control unit 7.

As a modified example, the first switch 3 and the second switch 4 may be each a physical switch instead of an electrostatic capacitance type switch. That is, the first switch 3 and the second switch 4 have microswitches at positions of the detection electrode 30 and the detection electrodes 41a to 44a, and are turned on by the deformation of the panel 2 by the operation to detect the operation.

(Configurations of First Illumination Unit 5 and Second Illumination Unit 6)

The first illumination unit 5 and the second illumination unit 6 are electrically connected to the control unit 7. Each of the first illumination unit 5 and the second illumination unit 6 is, for example, a light emitting element as a light-emitting diode (LED) which outputs white light, but is not limited thereto. As illustrated in FIG. 1B, the first illumination unit 5 is disposed on a substrate 10 below the first design 21.

The second illumination unit 6 includes a plurality of light emitting elements. In the second illumination unit 6, as illustrated in FIG. 3B, light emitting elements 61 to 65 are disposed on the substrate 10 below the high set temperature design 220, the low set temperature design 221, the high air volume design 222, the low air volume design 223, and the air volume design 224.

In the second illumination unit 6, light emitting elements 66 to 69 are disposed on the substrate 10 below the reception design 220a, the reception design 221a, the reception design 222a, and the reception design 223a. The reception design 220a, the reception design 221a, the reception design 222a, and the reception design 223a are designs surrounding the high set temperature design 220, the low set temperature design 221, the high air volume design 222, and the low air volume design 223, respectively, and therefore the design may be illuminated by two light emitting elements with the design interposed therebetween, may be illuminated by one light emitting element using a ride guide, or may be illuminated by a frame formed so as to be illuminated by one light emitting element. FIG. 3B illustrates a configuration in which illumination is performed by one light emitting element as an example.

The first illumination unit 5 illuminates the first design 21 based on an illumination signal S₆ output from the control unit 7 to bring the first design 21 into the display state. The second illumination unit 6 illuminates the second design 22 based on an illumination signal S₇ to an illumination signal S₁₁ output from the control unit 7 to bring the second design 22 into the display state.

The high set temperature design 220, the low set temperature design 221, the high air volume design 222, the low air volume design 223, and the air volume design 224 are illuminated according to the illumination signals S₇ to S₁₁ output to the light emitting elements 61 to 65. The reception design 220a, the reception design 221a, the reception design 222a, and the reception design 223a are illuminated according to illumination signals S₁₂ to S₁₅ output to the light emitting elements 66 to 69.

(Configuration of Control Unit 7)

The control unit 7 is, for example, a microcomputer including a central processing unit (CPU) which performs calculation, processing, and the like on acquired data according to a stored program, a random access memory (RAM) and a read only memory (ROM) which are semi-conductor memories, and the like. The ROM stores, for example, a program for operating the control unit 7. The RAM is used as, for example, a storage area for temporarily storing calculation results and the like.

The control unit 7 outputs operation information S₁₆ including information on the switch in which the touch operation is detected to the connected electronic device 95.

The control unit 7 outputs the illumination signal S₆ to the first illumination unit 5 based on vehicle information S₂₀ output from the vehicle control device 90 to illuminate the first design 21. Further, when the control unit 7 determines that the touch operation is detected by the first switch 3 based on the detection signal S₁, the control unit 7 outputs the illumination signals S₇ to S₁₁ to the second illumination unit 6 to illuminate the second design 22.

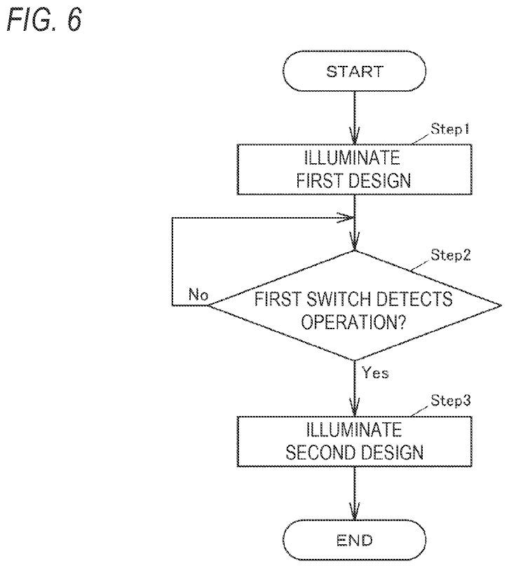

Hereinafter, an example of an operation related to the illumination of the first design 21 and the second design 22 of the switch device 1 according to the present embodiment will be described according to a flowchart of FIG. 6.

(Operation)

When it is determined that the vehicle 9 is unlocked based on the vehicle information S₂₀ input from the vehicle control device 90, the control unit 7 of the switch device 1 outputs the illumination signal S₆ to the first illumination unit 5 to illuminate the first design 21 (Step 1).

The control unit 7 monitors whether the touch operation is performed on the first design 21 based on the detection signal S₁ input from the first switch 3. When “Yes” of Step 2 is established, that is, when the first switch 3 detects the touch operation (Step 2: Yes), the control unit 7 outputs the illumination signals S₇ to S₁₁ to the second illumination unit 6 to illuminate the second design 22 (Step 3).

### Effects of Embodiment

The switch device 1 according to the present embodiment can improve visibility. Specifically, the switch device 1 can set the second design 22 in the non-display state into the display state by the touch operation on the first design 21 in the display state, and therefore it is possible to improve the visibility of the first design 21 which receives the operation, compared to a case where the design is in the non-display state.

In the switch device 1, only the first design 21 is in the display state in the initial state, and therefore visual complexity caused by displaying more designs is prevented as compared with a case where all designs are in the display state.

In the switch device 1, since the design associated with a target to be operated is the first design 21, the target to be operated can be easily understood before the operation and operability is improved as compared with a case where this configuration is not adopted.

Although the embodiment and the modified example of the present invention have been described above, these embodiment and modified example are merely examples and do not limit the present invention according to the claims. These novel embodiment and modified example can be implemented in various other forms, and various omissions, replacements, changes, and the like can be made without departing from the gist of the present invention. In addition, all combinations of features described in the embodiment and the modified example are not necessarily essential for the means for solving the problem of the invention. The accompanying claims and their equivalents are intended to cover the embodiment and the modified example as would fall within the scope and spirit of the invention.

What is claimed is:

1. A switch device comprising:
a panel having a first design and a second design;
a first switch configured to detect an operation performed on the first design displayed on the panel;
a second switch configured to detect an operation performed on the second design displayed on the panel; and
a control unit configured to set a display state in which the first design is displayed and a non-display state in which the second design is not displayed, in an initial state, and switch the second design from the non-display state to the display state based on an operation to the first switch.

2. The switch device according to claim 1, wherein
the second switch includes a plurality of switches, has the second design for each of the plurality of switches, and is assigned with a function to be operated.

3. The switch device according to claim 2, wherein:
the panel is mounted on a vehicle; and
the first design is displayed on the panel with unlocking of the vehicle as the initial state.

4. The switch device according to claim 3, wherein
the first design is a design related to the second design.

5. The switch device according to claim 4, wherein
the second design has a reception design displayed on the panel in response to reception of an operation to the second switch.

6. The switch device according to claim 1, further comprising:
a first illumination unit configured to illuminate the first design and display the first design on the panel; and
a second illumination unit configured to illuminate the second design and display the second design on the panel.
